(19) United States
(12) Patent Application Publication
(10) Pub. No.: US 2013/0028695 A1
(43) Pub. Date: Jan. 31, 2013

(54) HYDRAULIC CIRCUIT AND WORKING MACHINE INCLUDING THE SAME

(71) Applicant: Ian Blakeman, Rocester (GB)

(72) Inventor: Ian Blakeman, Rocester (GB)

(73) Assignee: J.C. Bamford Excavators Limited, Rocester (GB)

(21) Appl. No.: 13/450,673

(22) Filed: Apr. 19, 2012

(30) Foreign Application Priority Data
Apr. 20, 2011 (GB) 1106687.5

(51) Int. Cl. E02F 3/42; F15B 13/042

(52) U.S. Cl. 414/685; 60/459; 60/464

(57) ABSTRACT

A working machine hydraulic circuit, including: a hydraulic motor; a pilot pressure system configured to supply hydraulic fluid at a pilot pressure to one or more components of the working machine; and a make-up pressure system in hydraulic fluid communication with the pilot pressure system and the hydraulic motor, and configured to supply hydraulic fluid to the hydraulic motor from the pilot pressure system if the hydraulic fluid pressure in a part of the hydraulic motor is below a threshold pressure such that, during deceleration of the hydraulic motor, the make-up pressure system is operable to supply fluid from the pilot pressure system to the hydraulic motor to reduce the risk of cavitation in the hydraulic motor.

### CROSS-REFERENCE TO RELATED APPLICATION

This application claims priority to United Kingdom Patent Application No. GB 1106687.5, filed Apr. 20, 2011, which is incorporated herein by reference to the extent not inconsistent herewith.

### BACKGROUND OF THE INVENTION

Embodiments of the present invention relate to working machines, hydraulic circuits and parts thereof for working machines, and the like.

Many working machines, such as excavators, (see FIG. 1) include an undercarriage which carries a pair of parallel endless tracks which are configured to be driven in a rotational manner with respect to the undercarriage by a driving arrangement of the machine. The tracks are operable to engage the ground surface such that driving of one or both of the tracks in a rotational manner with respect to the undercarriage will cause movement of the machine with respect to the ground surface. Furthermore, by controlling the rate of rotational movement of each track with respect to the other track, the rotational position of the undercarriage with respect to the ground surface can be controlled to provide steering for the machine.

In a typical working machine of this type, the undercarriage supports a main body of the working machine and typically includes an operator cab which houses user operable controls which control the operation of the working machine.

The main body of the working machine is typically coupled to a boom which is connected to a dipper arm by a pivotal joint. A proximal end of the boom is attached through a pivotal connection to the main body and a distal end of the boom is connected to a proximal end of the dipper arm. A distal end of the dipper arm carries a working implement or tool.

The main body of the working machine can typically rotate with respect to the undercarriage such that the main body, the boom and the working implement can be moved between a first and a second rotational position with respect to the undercarriage. This allows, for example, material collected by the working implement at a first location to be deposited by the working implement at a second location (the first and second locations being rotationally offset from each other with respect to the undercarriage) without the need to move the undercarriage with respect to the ground surface. The rotational movement is referred to as a slew operation of the working machine.

The slew operation is normally driven by a hydraulic motor (known as a slew motor). The hydraulic motor is controlled and operated by a hydraulic circuit. A typical conventional hydraulic circuit for the control and operation of a slew motor is depicted in FIG. 2.

In order to reduce the risk of cavitation during deceleration of the hydraulic motor (due to the inertia of a moving part of the hydraulic motor causing the motor to act as a pump) it is necessary to provide a make-up fluid supply which is configured to supply fluid to the hydraulic motor during operation thereof in the event of a drop of fluid pressure in a hydraulic fluid supply conduit of the hydraulic motor (as a result of the pumping action during deceleration of the motor). In the example shown in FIG. 2, this make-up fluid supply comprises a conduit connected between a return conduit of a main control valve and the conduits which connect the main control valve to the hydraulic motor.

The make-up fluid pressure supply comprises a parasitic load on the hydraulic circuit which requires the hydraulic pump to be rated and operated for a higher load than would otherwise be required.

There is, therefore, a need to overcome one or more problems associated with the prior art.

### SUMMARY OF THE INVENTION

Accordingly, an aspect of the present invention provides a working machine hydraulic circuit, including: a hydraulic motor; a pilot pressure system configured to supply hydraulic fluid at a pilot pressure to one or more components of the working machine; and a make-up pressure system in hydraulic fluid communication with the pilot pressure system and the hydraulic motor, and configured to supply hydraulic fluid to the hydraulic motor from the pilot pressure system if the hydraulic fluid pressure in a part of the hydraulic motor is below a threshold pressure such that, during deceleration of the hydraulic motor, the make-up pressure system is operable to supply fluid from the pilot pressure system to the hydraulic motor to reduce the risk of cavitation in the hydraulic motor.

The circuit may further include: a hydraulic actuator coupled to the pilot pressure system by a control valve and configured for actuation between a first position and a second position on the supply of hydraulic fluid from the pilot pressure system to the control valve.

The hydraulic motor may be a slew motor.

The make-up pressure system may further include a valve configured to restrict or substantially prevent the flow of fluid from the hydraulic motor to the pilot pressure system.

The make-up pressure system may further include a valve configured to restrict or substantially prevent the flow of fluid from the pilot pressure system to the hydraulic motor when a fluid pressure in the pilot pressure system is less than a threshold fluid pressure.

The make-up pressure system may further include a valve configured to restrict or substantially prevent the flow of fluid from the hydraulic motor to the pilot pressure system and configured to restrict or substantially prevent the flow of fluid from the pilot pressure system to the hydraulic motor when a fluid pressure in the pilot pressure system is less than a threshold fluid pressure.

The valve may include a check valve.

The valve may include a solenoid valve.

The valve may include a pilot operated valve.

Another aspect of the invention provides a working machine including a hydraulic circuit.

The machine may further include a working arm and the pilot pressure system is configured to supply hydraulic fluid to one or more control valves associated with one or more hydraulic actuators of the working machine which are configured to drive the operation of the working arm or a part of the working arm.

The machine may be an excavator.

### BRIEF DESCRIPTION OF THE DRAWINGS

Embodiments of the present invention are described, by way of example, with reference to the accompanying drawings in which:

FIG. 1 shows a working machine;

FIG. 2 shows a conventional hydraulic circuit; and

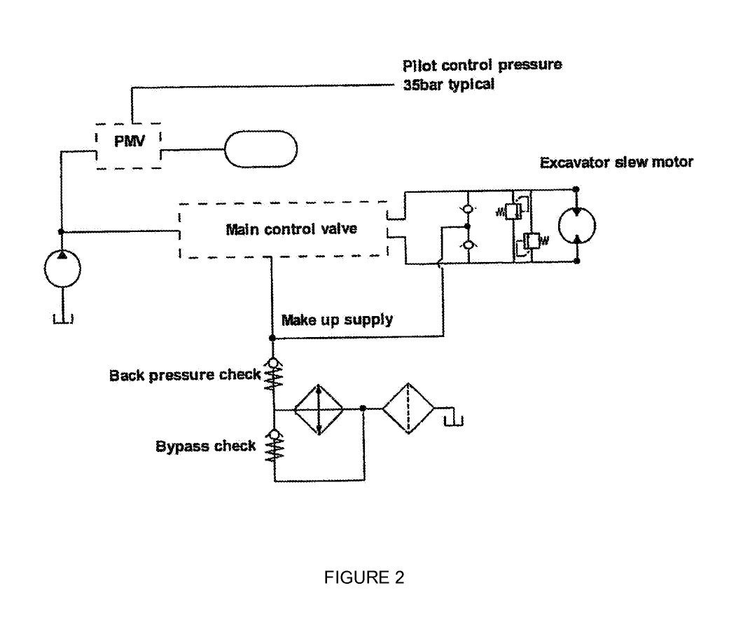

FIG. 3 shows a hydraulic circuit.

### DETAILED DESCRIPTION OF THE INVENTION

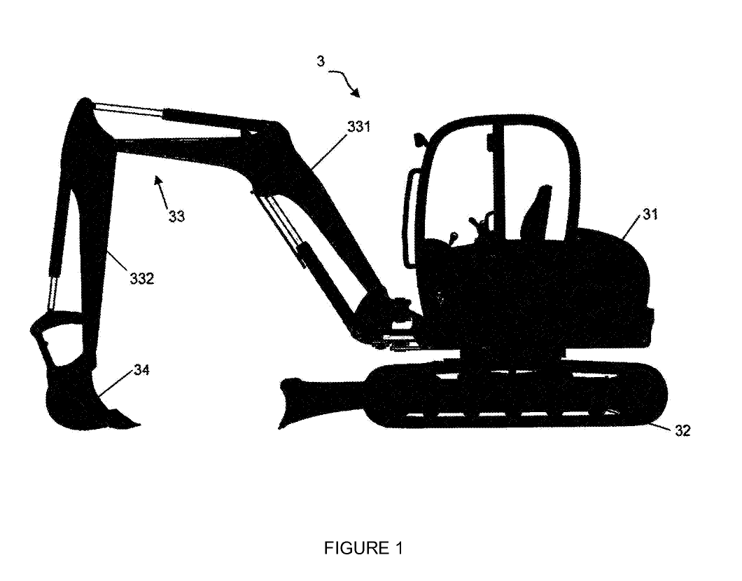

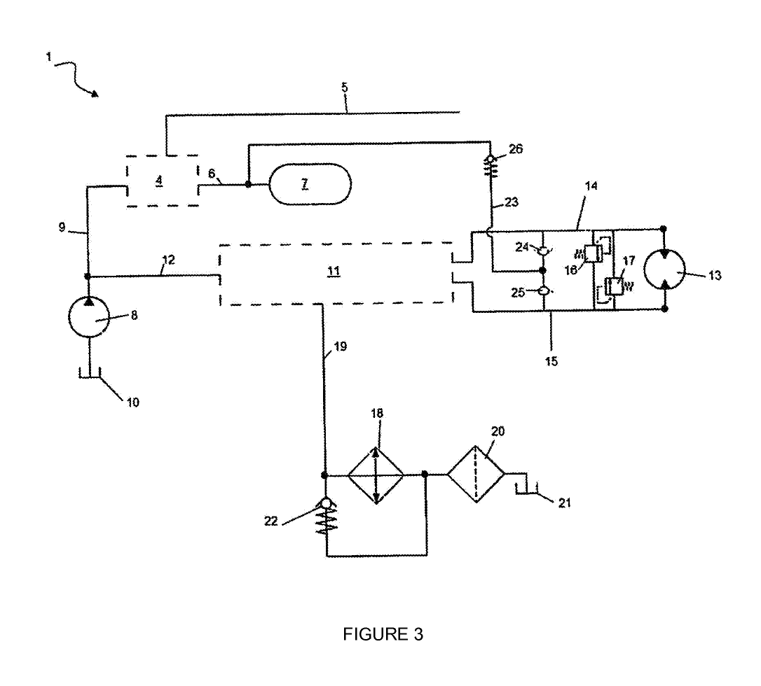

With reference to FIG. 3, an embodiment of the present invention comprises a hydraulic circuit 1 for slew motor control 2 of a working machine 3 (see FIG. 1).

The hydraulic circuit 1 is configured to control the operation of a hydraulic motor 13 (a slew motor) which is coupled to the working machine 3 such that operation of the hydraulic motor 13 causes rotation of a main body 31 with respect to an undercarriage 32 of the working machine 3 (a slew operation).

The hydraulic circuit 1 may be located in the main body 31 of the working machine 3 or in the undercarriage 32 of the working machine 3 or may be partially located in both the main body 31 and the undercarriage 32 of the working machine 3. Preferably, the hydraulic circuit 1 is located in the main body 31 of the machine 3.

The main body 31 may, in an embodiment, be attached to a working arm 33. The working arm 33 is attached at a proximal end thereof to the main body 31 of the working machine 3 and a distal end of the boom 33 is configured to carry a working implement or tool 34 (such as a bucket). The working arm 33 may be pivotally connected to the main body 31 such that it can be raised and lowered with respect to the main body 31 and may include one or more pivotal joints. The working arm 33 may be pivotally connected to the main body 31 such that it can be rotated between a left and a right position with respect to the main body 31.

Accordingly, the working arm 33 may comprise a first section 331 (a boom) attached to the main body 31 and a second section 332 (a dipper arm) attached to the first section 331 by a pivotal joint. One or more hydraulic rams or other hydraulic actuators may be provided to move the working arm 33 or a part or section thereof with respect to the main body 31. The or each hydraulic ram or actuator includes a hydraulic circuit and may include one or more control valves which are operated, at least in part, by a pilot pressure supply which can be actuated by a user operating a user control. The pilot pressure supply is provided by a pilot pressure system of the machine 3 and may be used to control the operation of one or more parts of the machine 3. The or each hydraulic ram or actuator is configured for movement between a first and a second position and to drive movement of the working arm 33 (for example) between a first and a second position. Other configurations of the working arm 33 are provided in accordance with embodiments of the present invention.

The main body 31 houses an engine for the machine 3.

In the circuit shown in FIG. 3, a system pilot pressure (typically around 35 bar (3500 KPa)) is provided by a pressure maintaining valve 4 along a pilot pressure conduit 5. This system pilot pressure may be used by other components of the working machine 3—for example, to control one or more spools of a main control valve to operate a ram coupled to the working arm 33. The pilot pressure conduit 5 may, therefore, be connected to or form part of a pilot pressure system of the machine 3.

The pressure maintaining valve 4 is coupled by a first conduit 6 to an accumulator 7 such that the pressure maintaining valve 4 and accumulator 7 are in fluid communication. The pressure maintaining valve 4 is also coupled to a hydraulic pump 8 by a second conduit 9 such that the pressure maintaining valve 4 and hydraulic pump 8 are in fluid communication. The hydraulic pump 8 is in fluid communication with a low pressure hydraulic fluid reservoir 10.

Thus, the pressure maintaining valve 4 uses fluid supplied under pressure from the hydraulic pump 8 to provide the system pilot pressure. The accumulator 7 is used to ensure that this system pilot pressure is maintained substantially at a predetermined level during operation of the working machine 3. The pressure maintaining valve 4 and the accumulator 7 may, therefore, form part of the pilot pressure system of the machine 3.

A main control valve 11 is coupled to the hydraulic pump 8 by a main control valve supply conduit 12 such that the main control valve 11 and hydraulic pump 8 are in fluid communication. The main control valve supply conduit 12 connects, in this example, to the second conduit 9.

The main control valve 11 is coupled to a hydraulic motor 13 (e.g. a slew motor) by third 14 and fourth 15 conduits such that the main control valve 11 is in fluid communication with the hydraulic motor 13. The arrangement is such that to drive a moving part of the hydraulic motor 13 in a first direction, fluid under pressure is supplied to the hydraulic motor 13 from the main control valve 11 through the third conduit 14 and fluid is passed from the hydraulic motor 13 to the main control valve 11 through the fourth conduit 15. To drive a moving part of the hydraulic motor 13 in a second direction fluid under pressure is supplied to the hydraulic motor 13 from the main control valve 11 through the fourth conduit 15 and fluid is passed from the hydraulic motor 13 to the main control valve 11 through the third conduit 14.

It will be appreciated that the main control valve 11 may comprise multiple valves forming a hydraulic control circuit and the operation of the main control valve 11 may be controlled by a user through user controls which may be provide in the main body 31 of the machine 3 (in an operator cab thereof).

In an embodiment, first 16 and second 17 relief valves are provided between the third 14 and fourth 15 conduits and are both connected in parallel with the hydraulic motor 13 in fluid communication therewith. In this embodiment, the two pressure relief valves 16,17 are arranged in an opposing configuration with respect to each other—the first relief valve 16 being configured to relieve an excessive fluid pressure in the third conduit 14 by allowing fluid to pass to the fourth conduit 15 and the second relief valve 17 being configured to relieve an excessive fluid pressure in the fourth conduit 15 by allowing fluid to pass to the third conduit 14 (the first 16 and second 17 relief valves normally being closed).

In an embodiment, when the main control valve 11 is operated so as not to drive movement of a moving part of the hydraulic motor 13, fluid is prevented by the main control valve 11 from entering or leaving the third 14 and fourth 15 conduits. In some scenarios, a moving part of the hydraulic motor 13 may have significant momentum when the control valve 11 is operated to prevent substantive quantities of fluid from entering or leaving the third 14 and fourth 15 conduits. Accordingly, depending on the direction of movement (e.g. rotation) of a moving part of the hydraulic motor 13 at that juncture, the fluid pressure in the third 13 or fourth 14 conduit may increase and this fluid pressure may be relieved through the relevant relief valve 16,17. As will be understood, this has the effect of damping the deceleration of a moving part of the hydraulic motor 13.

In an embodiment, the main control valve 11 is coupled to, and is in fluid communication with, a cooler 18 by a fifth conduit 19 which provides a return conduit for the main control valve 11. In this embodiment, the cooler 18 is configured to cool hydraulic fluid flowing therethrough and is in fluid communication with a filter 20. In this embodiment, the filter 20 is in fluid communication with a low pressure reservoir 21 of hydraulic fluid which may be the same reservoir 10 as is coupled to the hydraulic pump 8.

A bypass check valve 22 may be provided and may be connected in parallel with the cooler 18 such that if the fluid pressure in the fifth conduit 19 exceeds the cracking pressure of the bypass check valve 22, the bypass check valve 22 will allow fluid to bypass the cooler 18 such that fluid can pass from the fifth conduit 19 to the filter 20 without passing through the cooler 18. Thus, the bypass check valve 22 can be used to permit a portion of the fluid in the fifth conduit 19 to bypass the cooler 18 whilst allowing a portion of the fluid in the fifth conduit 19 to pass through the cooler 18. The bypass check valve 22 acts to control the fluid pressure of the fluid which passes through the cooler 18. The bypass check valve 22, therefore, acts to protect the cooler 18 from excessive fluid pressure.

During operation, when the movement of a moving part the hydraulic motor 13 is slowing (i.e. during deceleration of the motor 13 and, therefore, deceleration of rotational movement of the main body 31) there is a risk of cavitation in the hydraulic motor 13. This is caused by the inertia of a moving part of the hydraulic motor 13 (which is coupled to the main body 31 and, hence, the inertia of the main body 31 is also imparted to the moving part of the hydraulic motor 13 to contribute to the inertia thereof) which causes the motor to act as a pump during deceleration thereof. The risk is present during gradual declaration or sudden stopping of a moving part of the hydraulic motor 13—for example. To reduce this risk, a make-up pressure conduit 23 is connected, in an embodiment, by a first make-up pressure check valve 24 to the third conduit 14 and by a second make-up pressure check valve 25 to the fourth conduit 15. The first make-up check valve 24 is arranged such that fluid can pass from the make-up pressure conduit 23 to the third conduit 14 but fluid is prevented from flowing in the opposing direction. Similarly, the second make-up check valve 25 is arranged such that fluid can pass from the make-up pressure conduit 23 to the fourth conduit 15 but fluid is prevented from flowing in the opposing direction.

Fluid is supplied through the make-up pressure conduit 23 at a make-up fluid pressure such that fluid passes through the first make-up check valve 24 to the third conduit 14 if the fluid pressure in the third conduit 14 falls below the make-up fluid pressure, and fluid passes through the second make-up check valve 25 to the fourth conduit 15 if the fluid pressure in the fourth conduit 15 falls below the make-up fluid pressure.

Thus, as will be appreciated, fluid is supplied to the hydraulic motor if there is a sufficient fluid pressure drop in either the third or the fourth conduit 14, 15 with a view to reducing the likelihood of cavitation in the hydraulic motor 13.

In an embodiment, the make-up pressure conduit 23 is connected to the accumulator 7 and is in fluid communication therewith. In an embodiment, the make-up pressure conduit 23 is connected to the pilot pressure conduit 5 and is in fluid communication therewith. In an embodiment, the make-up pressure conduit 23 is connected to another part of a pilot pressure system of the working machine 3 and is in fluid communication therewith. The fluid pressure within the pilot pressure conduit 5 is, in an embodiment, operated in isolation from the fluid pressure in the make-up pressure conduit 23.

In an embodiment, the make-up pressure conduit 23 is connected to the first conduit 6 and is in fluid communication with the first conduit 6. Thus, the make-up fluid pressure is provided by the accumulator 7, the pressure maintaining valve 4, and the hydraulic pump 8. The make-up pressure is, in other words, provided by the pilot pressure system of the working machine 3 and does not form a continuous parasitic load on fluid pressure in the return conduit (the fifth conduit 19) of the main control valve 11. This allows a reduction in the back pressure required for operation of the hydraulic circuit 1.

Thus, a less powerful hydraulic pump 8 may be used and/or the fuel volume required to operate the hydraulic pump 8 for a given period may be lower.

In an embodiment, a make-up pressure valve 26 is provided in the make-up pressure conduit 23. The make-up pressure valve 26 may be a check valve. The make-up pressure valve 26 is configured to prevent the flow of fluid towards the accumulator 7 and to permit the flow of fluid from the accumulator 7 if the fluid pressure is higher than a predetermined fluid pressure (this may be achieved by selecting a check valve with an appropriate cracking pressure if the make-up pressure valve 26 is a check valve). In an embodiment in which the make-up pressure conduit 23 is connected to some other part of the pilot pressure system of the machine 3, then a make-up pressure valve 26 may be provided in the make-up pressure conduit 23 to prevent the flow of fluid towards the pilot pressure system and to permit the flow of fluid from the pilot pressure system if the fluid pressure is above a predetermined fluid pressure.

The make-up pressure check valve 26 provides a mechanism by which the balance can be defined between the use of the pilot fluid pressure in the pilot pressure system of the working machine 3 and the use of the pilot pressure as a source of make-up fluid pressure to reduce the risk of cavitation in the hydraulic motor. The cracking pressure of the make-up pressure check valve 26, therefore, may be selected in accordance with the operating characteristics of the pilot pressure system of the machine 3.

The make-up pressure check valve 26 also helps to reduce the risk of fluid passing from the hydraulic motor 8 back into the pilot pressure system of the working machine 3 in the event of failure of the first 24 or second 25 make-up pressure valves. Such a malfunction could otherwise damage components of the pilot pressure system.

The make-up pressure check valve 26 also acts to reduce the risk of fluid from the pilot pressure system of the working machine 3 from being exhausted if a slew operation is performed while the hydraulic pump 8 is not operating (perhaps because the working machine 3 engine is turned off). This allows operations such as an emergency lowering of the working arm 33 to take place in such circumstances (as there will still be sufficient pilot clued pressure in the pilot pressure system to allow for control of the working arm 33). This may, for example, be requirement of safety legislation in some territories.

Instead of the make-up pressure valve 26 being a check valve, a make-up pressure pilot valve or solenoid valve may be provided and configured for actuation such that a similar result is achieved. Of course, as will be appreciated, the make-up pressure valve 26 may comprise a combination of valves.

The make-up pressure conduit 23 and the first and second make-up pressure check valves 24, 25 for a make-up pressure system. The first and second make-up pressure check valves 24, 25 are just one example of an arrangement which allows fluid from the make-up pressure conduit to be supplied to the part of the hydraulic motor 13 in which it is required to reduce the risk of cavitation in the hydraulic motor 13. In an embodiment, the make-up pressure check valves 24, 25 are housed in a main body of the hydraulic motor 13.

The embodiments described above have made specific reference to a hydraulic motor used to perform a slew operation of the working machine 3. It will be appreciated that embodiments of the present invention may be used in relation to hydraulic motors configured for other operations.

The working machine 3 is preferably an excavator machine but it will be appreciated that embodiments of the present invention may be used in relation to other types of working machine 3 which are capable of a slew operation or, indeed, in relation to other working machines 3 which have hydraulic motors for other operations—such operations may include operations in which load holding of a spool of the main control valve 11 is required.

The working machine 3 may have an undercarriage 32 which includes one or more wheels and/or one or more endless tracks.

References made herein to the prevention of an act include the absolute prevention of that act or the substantial prevention of that act. Similarly, references made herein to the permitting or allowing of an act include the absolute unrestricted allowing or permitting of that act or the substantial allowing or permitting of that act.

As used herein, the terms “comprises” and “comprising” are synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

One of ordinary skill in the art will appreciate that starting materials, materials, device elements, methods, and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

When a group of materials, compositions, components or compounds is disclosed herein, it is understood that all individual members of those groups and all subgroups thereof are disclosed separately. When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. In the disclosure and the claims, “and/or” means additionally or alternatively. Moreover, any use of a term in the singular also encompasses plural forms.

1. A working machine hydraulic circuit, including:
a hydraulic motor;
a pilot pressure system configured to supply hydraulic fluid at a pilot pressure to one or more components of the working machine; and
a make-up pressure system in hydraulic fluid communication with the pilot pressure system and the hydraulic motor, and configured to supply hydraulic fluid to the hydraulic motor from the pilot pressure system if the hydraulic fluid pressure in a part of the hydraulic motor is below a threshold pressure such that, during deceleration of the hydraulic motor, the make-up pressure system is operable to supply fluid from the pilot pressure system to the hydraulic motor to reduce the risk of cavitation in the hydraulic motor.

2. A circuit according to claim 1, further including:
a hydraulic actuator coupled to the pilot pressure system by a control valve and configured for actuation between a first position and a second position on the supply of hydraulic fluid from the pilot pressure system to the control valve.

3. A circuit according to claim 1, wherein the hydraulic motor is a slew motor.

4. A circuit according to claim 1, wherein the make-up pressure system further includes a valve configured to restrict or substantially prevent the flow of fluid from the hydraulic motor to the pilot pressure system.

5. A circuit according to claim 1, wherein the make-up pressure system further includes a valve configured to restrict or substantially prevent the flow of fluid from the pilot pressure system to the hydraulic motor when a fluid pressure in the pilot pressure system is less than a threshold fluid pressure.

6. A circuit according to claim 1, wherein the make-up pressure system further includes a valve configured to restrict or substantially prevent the flow of fluid from the hydraulic motor to the pilot pressure system and configured to restrict or substantially prevent the flow of fluid from the pilot pressure system to the hydraulic motor when a fluid pressure in the pilot pressure system is less than a threshold fluid pressure.

7. A circuit according to claim 4, wherein the valve includes a check valve.

8. A circuit according to claim 4, wherein the valve includes a solenoid valve.

9. A circuit according to claim 4, wherein the valve includes a pilot operated valve.

10. A working machine comprising the hydraulic circuit according to claim 1.

11. A working machine according to claim 10, wherein the machine further includes a working arm and the pilot pressure system is configured to supply hydraulic fluid to one or more control valves associated with one or more hydraulic actuators of the working machine which are configured to drive the operation of the working arm or a part of the working arm.

12. A working machine according to claim 10, wherein the machine is an excavator.
